(19) United States
(12) Patent Application Publication
(10) Pub. No.: US 2012/0033922 A1
(43) Pub. Date: Feb. 9, 2012

(54) OPTICAL CONNECTOR, REMOVAL TOOL, AND OPTICAL CONNECTOR-REMOVING STRUCTURE

(76) Inventor: Masaya NAKAGAWA, Kyoto-shi (JP)

(21) Appl. No.: 12/984,012

(22) Filed: Jan. 4, 2011

(30) Foreign Application Priority Data
Aug. 5, 2010 (JP) 2010-176325

(51) Int. Cl. G02B 6/36; B23P 19/00

(52) U.S. Cl. 385/78; 29/762

(57) ABSTRACT

Provided is an optical connector, including a covering member having a holding portion which surrounds the entire circumference of rear end of the housing, a covering portion which covers rear end of a locking lever, and a tool insertion hole which is provided between the holding portion and the covering portion so as to extend through the covering member in an optical axis direction.

### TECHNICAL FIELD

The present invention relates to an optical connector, a removal tool for removing the optical connector from an optical adapter, and an optical connector-removing structure including the same.

### BACKGROUND ART

The optical connector is intended to be attached to ends of optical fiber cables and then attached to the optical adapter (or an optical receptacle, the same shall apply hereinafter), to thereby connect the optical fiber cable to another optical fiber cable or optical communication module so as to provide optical communication.

For example, in Patent Literature 1, there is disclosed an optical connector, which has a locking lever for preventing the connector from coming off from the optical adapter. The optical connector is configured to engage the locking lever with the optical adapter to prevent the connector from coming off from the optical adapter. Pressing down and resiliently deforming the locking lever results in disengagement of the locking lever from the optical adapter, and the optical connector is allowed to be removed from the optical adapter.

### CITATION LIST

Patent Literature 1: Japanese Patent Application Laid-open No. 2009-109978

### SUMMARY OF INVENTION

### Technical Problem

The optical connector as described above can be removed from the optical adapter by anyone pushing down the locking lever. However, in the case of the optical connector connected to a server, for example, security problems may arise if it is feasible for anyone to remove the optical connector.

An object to be achieved by the present invention is to allow the removal of the optical connector from the optical adapter only by predetermined manipulations, thereby improving security.

### Solution to Problem

In order to achieve the above-mentioned object, the present invention provides an optical connector which includes: a ferrule attached to an end of an optical fiber; a housing for holding the ferrule; a locking lever having a locking portion which engage with an optical adapter, a front end fixed to a top surface of the housing, and a rear end capable of flexibly moving up and down; and a covering member having an holding portion which holds an entire outer periphery of the housing, a covering portion which covers top surface of the rear end of the locking lever, and a tool insertion hole which is provided between the holding portion and the covering portion so as to extend through the covering member in an optical axis direction.

Here, the “optical axis direction” refers to the direction in which the optical fiber extends (left-right direction of FIG. 2), an end side of the optical fiber in the optical axis direction (right side of FIG. 2) is referred to as “front” and the opposite side thereof (left side of FIG. 2) is referred to as “rear”. Further, one direction orthogonal to the optical axis direction is described as an up-down direction. However, this is defined for convenience of illustrating relative positional relationships among each of the components and not intended to limit use aspects of the optical connector.

In this way, the top surface of the rear end of the locking lever is covered by the covering portion, and hence the locking lever cannot be pressed from above. With this configuration, the removal of the optical connector from the optical adapter is restricted and security of an equipment connected to the optical connector (for example, a server) can be improved. The removal of the optical connector from the optical adapter is achieved by inserting the removal tool into the tool insertion hole of the covering member from the rear side of the connector and pushing down the rear end of the locking lever positioned under the covering portion.

In the optical connector as described above, if the covering portion deforms easily, there is a risk that the covering portion is pressed from above to deform, and the covering portion thus deformed in turn pushes down the locking lever, thereby causing the removal of the optical connector from the optical adapter. Thus, under a state in which the optical connector is attached to the optical adapter, if the covering portion extends to a position to partially cover a top surface of the optical adapter, even when the covering portion is pressed from above, the covering portion can abut the top surface of the optical adapter to restrict the deformation of the covering portion, to thereby reliably prevent the locking lever to be pushed down.

In addition, the optical adapter may have an engagement hole formed through the top surface thereof for engaging with the locking lever of the optical connector. If the locking lever is manipulated through this hole, there is a risk that the optical connector is removed from the optical adapter. Thus, under a state in which the optical connector is attached to the optical adapter, if the covering portion covers the engagement hole of the optical adapter, it is possible to prevent the locking lever from being manipulated through the engagement hole.

In the optical connector described above, the holding portion provided in the covering member has a cylindrical shape to hold the entire outer periphery of the housing. Therefore, assembly of the covering member and the housing is achieved, for example, by covering the holding portion over the housing from the rear side thereof. At this point, if the ferrule and the optical fiber cable have been already assembled to the housing, the optical fiber cable hinder the covering member from being assembled onto the housing from the rear side thereof. Thus, the holding portion of the covering member is configured to include an upper holding part which holds the top surface of the housing and a lower holding part which holds bottom surface of the housing. As a result, even when the ferrule and the optical fiber cable have been already assembled onto the housing, it is possible to assemble the upper holding part and the lower holding part in such a manner that the upper holding part and the lower holding part clamp the optical fiber cable from above and below, house the optical fiber cable within an inner periphery of the holding portion, and subsequently assemble the covering member onto the housing from the rear side thereof.

The optical connector described above can be removed from the optical adopter using a removal tool which includes an operation lever having a front end capable of flexibly moving up and down. Under a state in which the operation lever is inserted into the tool insertion hole from the rear side thereof, the front end of the operation lever is positioned above the rear end of the locking lever, and the rear end of the operation lever projects rearward from the tool insertion hole. Specifically, under the state in which the operation lever of the removal tool is inserted into the tool insertion hole from the rear side thereof, it is possible to press the rear end of the operation lever projecting rearward from the tool insertion hole from above to cause the front end of the operation lever to be pushed down, thereby pushing down the rear end of the locking lever. As a result, the locking lever of the optical connector is disengaged from the optical adapter, and the optical connector can be removed from the optical adapter.

If it is possible to remove all optical connectors by one kind of removal tool, any optical connector can be removed as long as the removal tool is available, and thus security may not necessarily be sufficient. Thus, according to an optical connector-removing structure according to the invention, a recessed portion (or a projecting portion) is provided in the top surface of the operation lever, and correspondingly a projecting portion (or a recessed portion) is provided in the tool insertion hole of the covering member of the optical connector. If the recessed portion of the operation lever fit with the projecting portion of the tool insertion hole, the front end of the operation lever inserted into the tool insertion hole is positioned above the rear end of the locking lever. In this case, it is possible to push down the operation lever to cause the locking lever to be pushed down, to thereby remove the optical connector from the optical adapter. On the other hand, if the recessed portion of the operation lever does not fit with the projecting portion of the tool insertion hole, the operation lever inserted into the tool insertion hole is pushed down by the projecting portion of the tool insertion hole, so that the front end of the operation lever cannot be positioned above the rear end of the locking lever. In this case, pushing down the operation lever does not cause the locking lever to be pushed down, and thus the optical connector cannot be removed from the optical adapter. Therefore, according to the optical connector-removing structure described above, only a specific removal tool which is adapted to the optical connector can be used for removing the optical connector from the optical adapter, thereby further improving security.

### Advantageous Effects of Invention

As described above, according to the present invention, in order to remove the optical connector from the optical adapter, it is required to provide an operation to insert the removal tool into the tool insertion hole of the covering member and push down the locking levers. As a result, it is possible to more reliably prevent the optical connector to be removed by an unauthorized person and improve security.

### BRIEF DESCRIPTION OF DRAWINGS

FIG. 1 illustrates a perspective view of the optical connector according to an embodiment of the present invention.

FIG. 2 illustrates a side view of the optical connector.

FIG. 3 illustrates a front view of the optical connector.

FIG. 4 illustrates a partial cross-sectional view of the optical connector.

FIG. 5 illustrates a perspective view of the covering member of the optical connector.

FIG. 6 illustrates a front view of the covering member.

FIG. 7A illustrates a perspective view of one of the steps of assembling the covering member of the optical connector.

FIG. 7B illustrates a perspective view of one of the steps of assembling the covering member of the optical connector.

FIG. 8 illustrates a perspective view of the removal tool adapted to the optical connector.

FIG. 9 illustrates a partial cross-sectional view of one of the steps of removing the optical connector from the optical adapter using the removal tool.

FIG. 10 illustrates a partial cross-sectional view of one of the steps of removing the optical connector from the optical adapter using the removal tool.

FIG. 11 illustrates a partial cross-sectional view of one of the steps removing the optical connector from the optical adapter using the removal tool.

FIG. 12 illustrates a partial cross-sectional view of one of the steps removing the optical connector from the optical adapter using the removal tool.

FIG. 13 illustrates a perspective view of the removal tool adapted to another optical connector.

FIG. 14 illustrates a partial cross-sectional view of the removal tool in FIG. 13 under a state of being attached to the optical connector in FIG. 1.

### DESCRIPTION OF EMBODIMENTS

An embodiment of the present invention is now described with reference to the drawings.

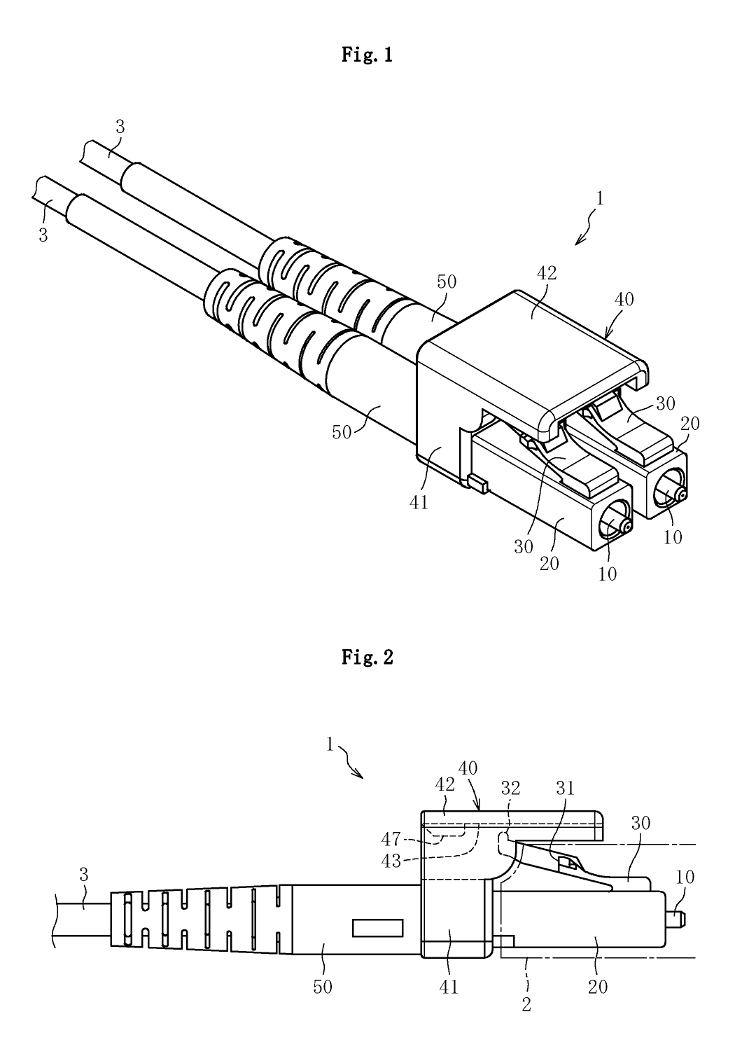

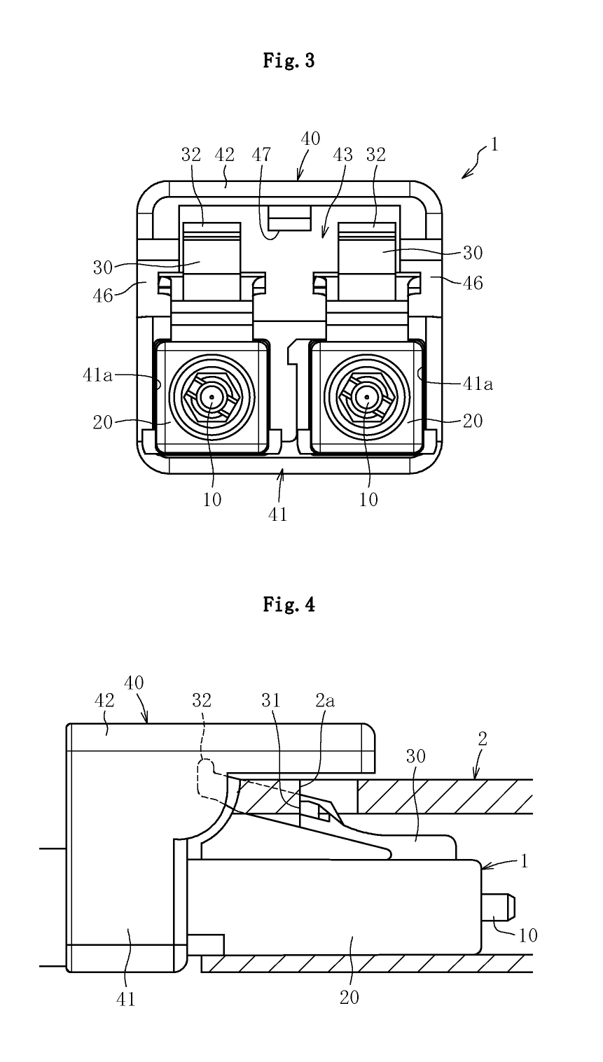

FIGS. 1 to 3 illustrate an optical connector 1 according to an embodiment of the present invention. The optical connector 1 is a LC type optical connector, and attached to ends of optical fiber cables 3 each having an optical fiber (not shown) therein. The optical connector 1 mainly includes ferrules 10 each attached to a end of one of the optical fibers, housings 20 each holding one of the ferrules 10, locking levers 30 each provided on a top surface of each of the housings 20, a covering member 40 attached to a rear end of the housings 20, and boots 50 each for protecting one of the optical fiber cables 3 which extend rearward from the housings 20. The optical connector 1 according to this embodiment is a so-called duplex optical connector, in which a pair of housings 20 is integrated into the covering member 40. Note that, an “up-down direction” refers to the height direction in FIG. 2, and a “width direction” refers to the direction orthogonal both to an optical axis direction and to the height direction (left-right direction in FIG. 3).

Each of the ferrules 10 has a through-hole (not shown) which extends in the optical axis direction and through which the optical fiber is inserted. By attaching the optical connector 1 to the optical adapter 2 (shown as a dot-dash line in FIG. 2), and causing each of the ends of the ferrules 10 to abut a corresponding one of the ends of the ferrules of a mating optical connector, the optical fibers are connected with each other so as to provide optical communication.

The housings 20 are, for example, formed of resin into a generally rectangular parallelepiped shape, which is adapted to be inserted into an attachment hole of the optical adapter 2. Each of the housings 20 holds one of the ferrules 10 within its inner periphery, and the ends of the ferrules 10 project forward from the housings 20. A spring (not shown) is provided inside each of the housings 20, which springs maintain the ferrules 10 in a forwardly biased state.

Each of the locking levers 30 is connected to the top surface of each of the housings 20 on the front end and apart from the top surface of each of the housings 20 on the rear end. As a result, it is possible to flexibly move the rear ends 32 of the locking levers 30 (see FIG. 2) up and down. In this embodiment, the locking levers 30 extend obliquely-upward and rearward from the top surfaces of the housings 20, and the locking levers 30 and the housings 20 are integrally molded of resin. Each of the locking levers 30 has locking portions 31 provided in the middle in the optical axis direction and on both sides in the width direction. As illustrated in FIG. 4, the locking portions 31 of the locking levers 30 engage with engagement holes 2a provided in the optical adapter 2 in the optical axis direction, to thereby prevent the optical connector 1 from coming off from the optical adapter 2. Flexibly pushing down the rear ends 32 of the locking levers 30 causes the locking portions 31 of the locking levers 30 to be disengaged from the engagement holes 2a of the optical adapter 2.

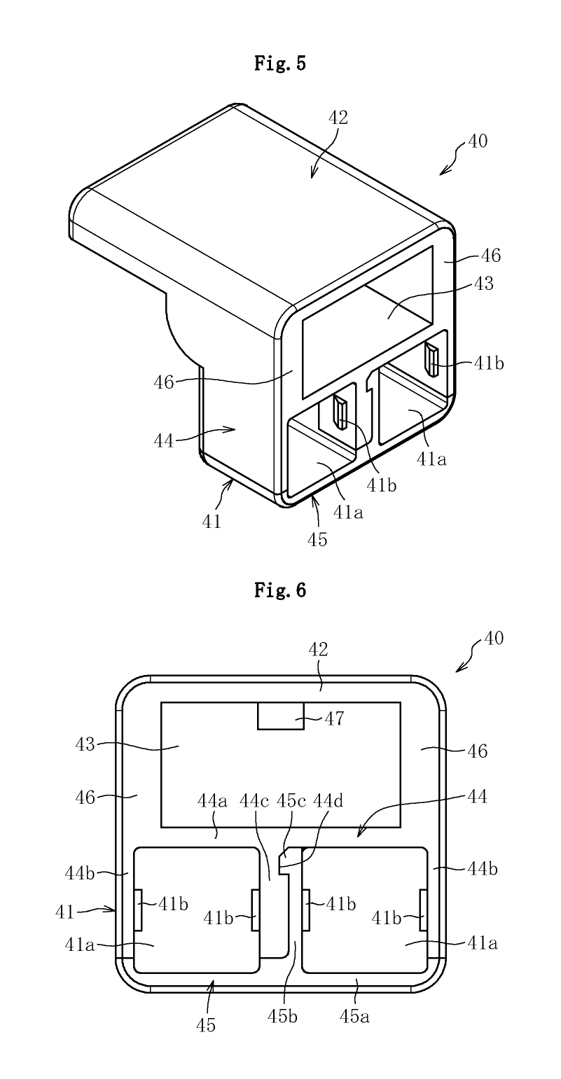

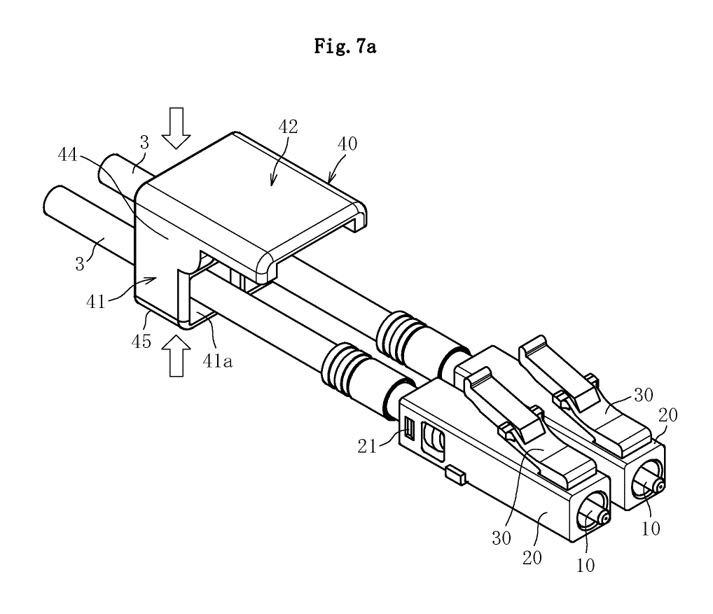

As illustrated in FIGS. 5 and 6, the covering member 40 includes a holding portion 41 which holds the entire outer periphery of the housings 20, a covering portion 42 which covers top surfaces of the locking levers 30, and a tool insertion hole 43 which is provided between the holding portion 41 and the covering portion 42 so as to extend through the covering member 40 in the optical axis direction.

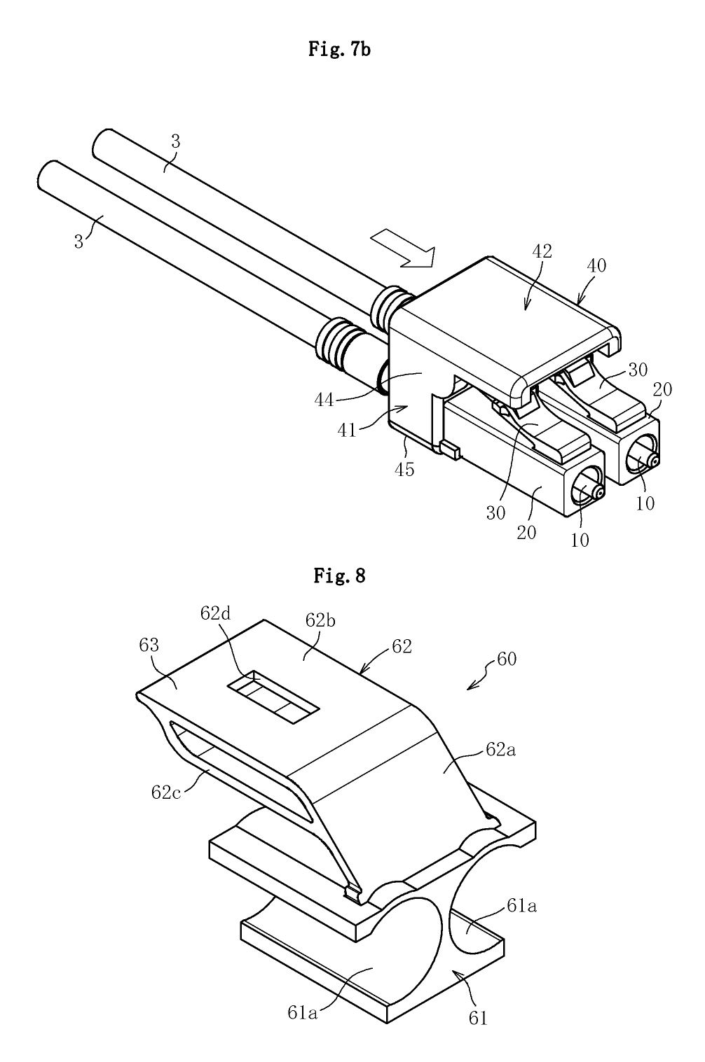

The holding portion 41 has a pair of holding holes 41a extending through the holding portion 41 in the optical axis direction. Inserting the rear ends of the housings 20 in these holding holes 41a allows the entire outer periphery of the rear ends of the housings 20 to be held by the holding portion 41. Engagement protrusions 41b are formed on the inner peripheral surfaces of the holding holes 41a. Specifically, each of a pair of holding holes 41a has two engagement protrusions 41b formed on both sides in the width direction of its inner wall. On the other hand, each of the housings 20 has two recessed portions 21 provided on both side surfaces in the width direction of the rear ends (see FIG. 7A). When the housings 20 are inserted into the holding holes 41a of the holding portion 41, the engagement protrusions 41b of the holding portion 41 fit in the recessed portions of the housings 20 and the engagement protrusions 41b and the recessed portions engage with each other in the optical axis direction, to thereby prevent coming off of the housings 20 relative to the holding portion 41.

As illustrated in FIG. 6, the holding portion 41 includes an upper holding part 44 and a lower holding part 45. The upper holding part 44 has an top wall portion 44a which holds top surfaces of the housings 20, a pair of outer wall portions 44b which hold side surfaces of the housings 20 on the outside in the width direction, and a central wall portion 44c which holds side surfaces of the housings 20 on the central side in the width direction. The lower holding part 45 has a bottom wall portion 45a which holds bottom surfaces of the housings 20 and a central wall portion 45b which holds sidewalls of the housings 20 on the central side in the width direction. Engagement of a locking claw 45c provided on the central wall portion 45b of the lower holding part 45 with a locking groove 44d provided on the central wall portion 44c of the upper holding part 44 causes the lower holding part 45 to be integrated with the upper holding part 44.

The covering portion 42 is provided above the holding portion 41 via a covering sidewall portions 46 which extend upward from a top surface of the holding portion 41 on both ends in the width direction. In this embodiment, the covering portion 42, the covering sidewall portions 46, and the upper holding part 44 are integrally molded of resin. The covering portion 42 bridges top ends of the covering sidewall portion 46, and extends forward to cover the top surfaces of the rear ends 32 of the locking levers 30 (see FIG. 2). A projecting portion 47 is provided on an underside of the covering portion 42. The projecting portion 47 has a different location and shape for each optical connector 1, and in the illustrated example, the projecting portion 47 is formed at the center in the width direction of the covering portion 42 and extends in the optical axis direction. The projecting portion 47 has, on its rear end, an inclined surface which is inclined rearward and obliquely-upward.

As illustrated in FIG. 6, the tool insertion hole 43 includes a space defined by the covering portion 42, the covering sidewall portions 46, and the top wall portion 44a of the upper holding part 44. In this embodiment, as viewed in the front view illustrated in FIG. 3, the rear ends 32 of a pair of the locking levers 30 are positioned within an inner periphery of the tool insertion hole 43.

Assembly of the covering member 40 to the housings 20 is achieved in the following steps, for example. First, as illustrated in FIG. 7A, the upper holding part 44 and the lower holding part 45 are assembled in such a manner that the upper holding part 44 and the lower holding part 45 clamp the optical fiber cables 3 from above and below, and the optical fiber cables 3 are positioned within the inner periphery of the holding holes 41a. Subsequently, as illustrated in FIG. 7B, the covering member 40 is moved forward, and the rear ends of the housings 20 are inserted into the holding holes 41a of the holding portion 41 of the covering member 40 from the front thereof. Then, the engagement protrusions 41b formed on the inner peripheral surfaces of holding holes 41a (see FIG. 6) are engaged with the recessed portions 21 of the housings 20 (FIG. 7A), thereby securing the covering member 40 and the housings 20.

As illustrated in FIG. 2, the rear ends 32 of the locking levers 30, which project rearward from the optical adapter 2, are covered by the above-located covering portion 42 of the covering member 40, and hence the locking levers 30 cannot be pressed from above. As a result, the removal of the optical connector 1 from the optical adapter 2 can be restricted. In particular, a front end of the covering portion 42 extends to a position to partially cover the top surface of the optical adapter 2. Therefore, even when the covering portion 42 is pressed from above, the covering portion 42 may abut the top surface of the optical adapter 2, to thereby reliably prevent the covering portion 42 from downwardly deforming and pushing down the locking levers 30.

Further, as illustrated in FIG. 4, the optical adapter 2 is formed with engagement holes 2a, which engages with the locking portions 31 of the locking levers 30. The engagement holes 2a are formed through the top surface of the optical adapter 2, for convenience of molding. When an elongated needle-like tool or the like is inserted into the engagement holes 2a and pushes down the locking levers 30, there is a risk that the locking portions 31 are disengaged from the engagement holes 2a and the optical connector 1 is removed from the optical adapter 2. Therefore, as illustrated in FIG. 4, by extending the covering portion 42 to a position to cover the engagement holes 2a of the optical adapter 2, it is possible to prevent the possibility of the engagement holes 2a being used to cause the removal of the optical connector 1.

A removal tool 60 for removing the optical connector 1 from the optical adapter 2 is illustrated in FIG. 8. The removal tool 60 includes a base portion 61 and an operation lever 62 which extends forward from a top surface of the base portion 61. The base portion 61 includes fitting portions 61a which fit around outer peripheral surfaces of the boots 50. The fitting portions 61a are partial cylindrical surfaces which are open in the outside in the width direction, and covers an area equal to or larger than half the circumference of the outer peripheral surfaces of the boots 50. When the fitting portions 61a fit around the outer peripheral surfaces of the boots 50, the removal tool 60 is aligned relative to the optical connector 1 in a direction orthogonal to the optical axis direction. In particular, the optical connector 1 according to this embodiment is a duplex optical connector, so that fitting one fitting portion 61a around the two boots 50 respectively enables restriction of the rotation of the removal tool 60 around the boots 50.

The operation lever 62 has a rear end connected to the base portion 61 and a front end 63 capable of flexibly moving up and down. Specifically, the operation lever 62 includes a inclined portion 62a extending obliquely-upward and forward from the top surface of the base portion 61, a horizontal portion 62b extending horizontally forward from a leading edge of the inclined portion 62a, and a reinforcing portion 62c. The front end 63 of the horizontal portion 62b is capable of flexibly moving up and down. In this embodiment, the operation lever 62 is integrally formed of resin. The horizontal portion 62b is provided with a recessed portion which fits with the projecting portion 47 provided on a bottom surface of the covering portion 42. In the illustrated example, a through-hole 62d extending up and down through the horizontal portion 62b is provided as the recessed portion. The through-hole 62d is provided at the center in the width direction of the horizontal portion 62b and has a rectangular shape extending in the optical axis direction. The reinforcing portion 62c is provided substantially parallel to the horizontal portion 62b, has a rear end connected to the middle of the inclined portion 62a, and has a front end connected close to the front end 63 of the horizontal portion 62b. In this way, providing the operation lever 62 with the reinforcing portion 62c allows for increased strength and elastic restoring force when pushing down the operation lever 62.

Hereinafter, steps of removing the optical connector 1 attached to the optical adapter 2 using the removal tool 60 is described.

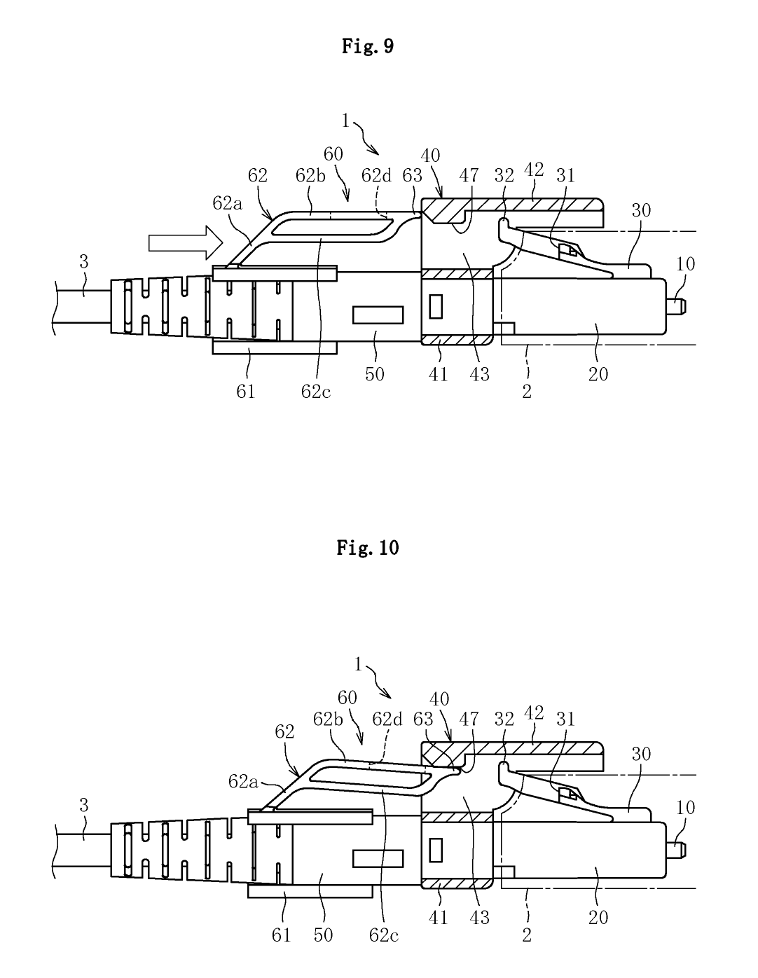

First, two optical fiber cables 3 are fitted into the fitting portions 61a of the base portion 61 of the removal tool 60. Next, the removal tool 60 is moved forward as illustrated in FIG. 9 to position the front end 63 of the operation lever 62 to a rear opening of the tool insertion hole 43 of the covering member 40. At this point, the base portion 61 of the removal tool 60 is in fitting relationship with two optical fiber cables 3, so that the movement of the removal tool 60 in the direction orthogonal to the optical axis direction is restricted. The shape of the removal tool 60 is determined to enable the operation lever 62 to be inserted into a predetermined position (close to the top end) of the tool insertion hole 43 when the removal tool 60 is moved forward in this state.

When the removal tool 60 is pushed further forward, as illustrated in FIG. 10, the front end 63 of the operation lever 62 is flexibly pushed down by the projecting portion 47 of the covering portion 42. In the course of this movement, the front end 63 of the operation lever 62 is guided along an inclined surface provided at the rear end of the projecting portion 47, and thus smoothly pushed down.

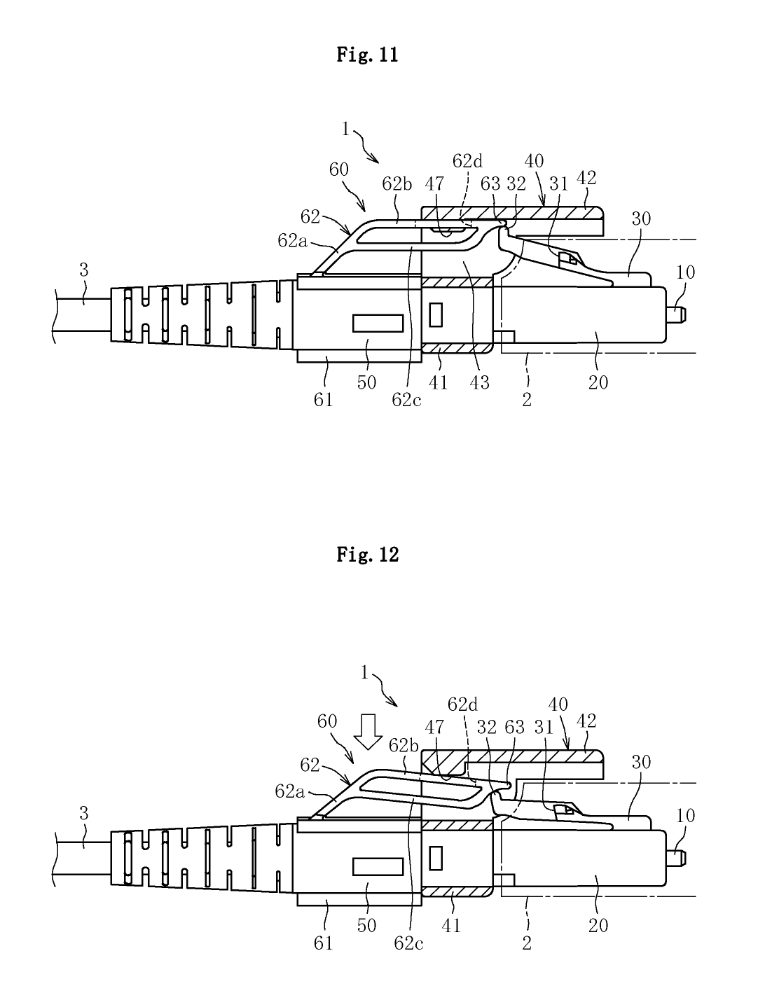

When the removal tool 60 is further pushed forward, as illustrated in FIG. 11, the projecting portion 47 of the covering portion 42 is fitted into the through-hole 62d provided in the horizontal portion 62b of the operation lever 62. At the same time, the operation lever 62 which has been pushed down by the projecting portion 47 flexibly returns to its original position, and the horizontal portion 62b of the operation lever 62 abuts or is brought into close proximity with the bottom surface of the covering portion 42. Then, the base portion 61 of the removal tool 60 abuts the holding portion 41 of the covering member 40, thereby completing the attachment of the removal tool 60 to the optical connector 1. At this point, the front end 63 of the operation lever 62 is positioned above the rear ends 32 of the locking levers 30. In addition, the rear end of the operation lever 62 projects rearward from the tool insertion hole 43 of the covering member 40. In the illustrated example, more than half part of the operation lever 62 is exposed to the outside.

Next, as indicated by an arrow in FIG. 12, the part of the operation lever 62 of the removal tool 60 which is exposed to the outside is pushed down from above. As a result, the operation lever 62 is flexibly deformed to cause the front end 63 to be pushed down, and the front end 63 of the operation lever 62 in turn pushes down the rear ends 32 of the locking levers 30. In this way, the locking portion 31 of the locking levers 30 is disengaged from the engagement hole 2a (see FIG. 4) of the optical adapter 2. Keeping this state and pulling the removal tool 60 and the optical connector 1 rearward allows the optical connector 1 to be removed from the optical adapter 2.

The optical connector 1 and the removal tool 60 described above are configured to enable the projecting portion 47 provided on the covering portion 42 to fit into the recessed portion (through-hole 62d) provided on the operation lever 62, to thereby position the rear ends 32 of the locking levers 30 above the front end 63 of the operation lever 62 (see FIG. 11). On the contrary, if the projecting portion 47 of the covering portion 42 does not fit into the through-hole 62d of the operation lever 62, the front end 63 of the operation lever 62 cannot be positioned above the rear ends 32 of the locking levers 30. This configuration is described in detail below.

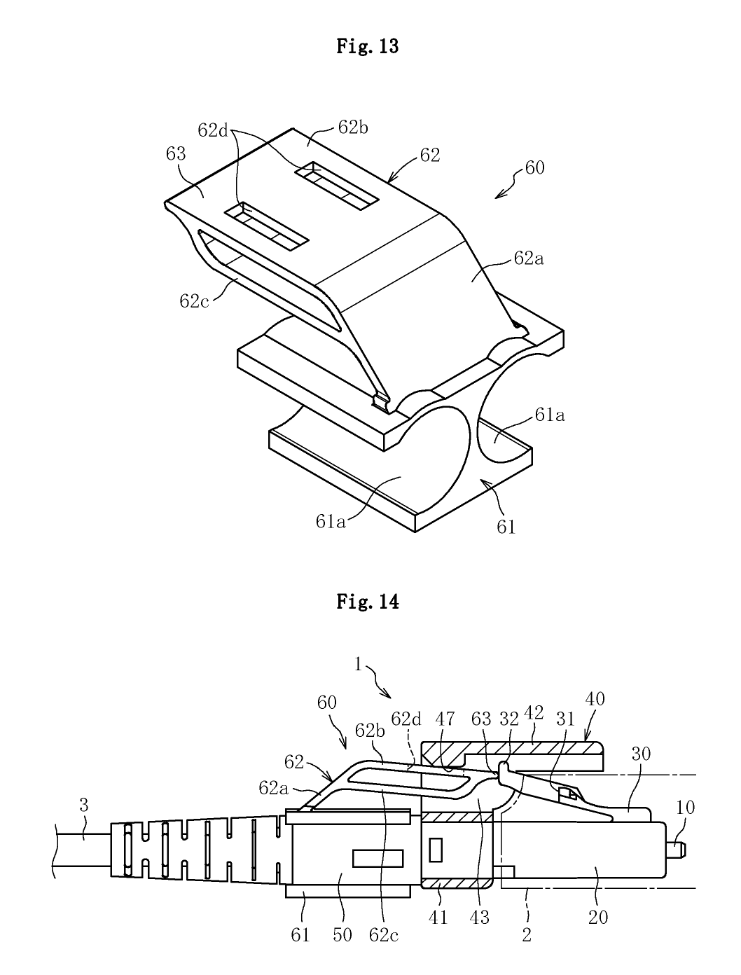

For example, the removal tool 60 illustrated in FIG. 13 has through-holes 62d formed at two positions spaced from each other in the width direction of the horizontal portion 62b of the operation lever 62. When the removal tool 60 is attached to the optical connector 1 described above, the projecting portion 47 and the through-holes 62d are not aligned with each other in the width direction, and thus the projecting portion 47 does not fit into the through-hole 62d. Accordingly, as illustrated in FIG. 14, the operation lever 62 continues to advance forward under a state of being held down by the projecting portion 47, the front end 63 of the operation lever 62 cannot be positioned above the rear ends 32 of the locking levers 30. In the illustrated example, the front end 63 of the operation lever 62 abuts the rear ends 32 of the locking levers 30 from the rear side thereof. If the operation lever 62 is pushed down in this state, the rear ends 32 of the locking levers 30 cannot be pushed down.

In this way, if the position and size of the projecting portion 47 of the covering portion 42 do not match those of the through-hole 62d of the operation lever 62, the optical connector 1 cannot be removed from the optical adapter 2 using the removal tool 60. In other words, in case of the optical connectors 1 attached to a plurality of optical connection terminals (optical adapters) provided on a server or the like, providing a different position and size of the projecting portion 47 on the covering portion 42 for each of the optical connector 1 leads to the necessity of using the removal tool 60 which has the recessed portion (through-hole 62d) fittable with the projecting portion 47 of the optical connector 1 when the optical connector is removed. In this way, the removal tool 60 serves as a “key” adapted to each of the optical connector 1, to thereby more reliably prevent the optical connector 1 to be removed by an unauthorized person and further improve security.

The present invention is not limited to the above-described embodiment. For example, although in the above-described embodiment the covering portion 42 is provided with the projecting portion 47 and the operation lever 62 is provided with the recessed portion (through-hole 62d), in contrast to this configuration, the covering portion 42 may be provided with the recessed portion and the operation lever 62 may be provided with the projecting portion.

In addition, although in the above-described embodiment the present invention is described as applied to the duplex optical connector 1, the present invention is not limited to this type of optical connector and is applicable to a simplex optical connector, for example.

### REFERENCE SIGNS LIST

1 optical connector
2 optical adapter
2a engagement hole
3 optical fiber cable
10 ferrule
20 housing
30 locking lever
31 locking portion
40 covering member
41 holding portion
42 covering portion
43 tool insertion hole
44 upper holding part
45 lower holding part
50 boot
60 removal tool
61 base portion
62 operation lever

1. An optical connector, comprising:
a ferrule being attached to an end of optical fiber;
a housing for holding the ferrule;
a locking lever each having a locking portion which engages with the optical adapter, a front end fixed to a top surface of the housing, and a rear end capable of flexibly moving up and down; and
a covering member having an holding portion which holds an entire outer periphery of the housing, a covering portion which covers a top surface of the rear end of the locking lever, and a tool insertion hole which is provided between the holding portion and the covering portion so as to extend through the covering member in an optical axis direction.

2. An optical connector according to claim 1, wherein under a state in which the optical connector is attached to the optical adapter, the covering portion extends to a position to partially cover a top surface of the optical adapter.

3. An optical connector according to claim 2, wherein under a state in which the optical connector is attached to the optical adapter, the covering portion extends to a position to cover an engagement hole provided in the top surface of the optical adapter.

4. An optical connector according to claim 1, wherein the holding portion of the covering member comprises an upper holding part which holds the top surfaces of the housing and a lower holding part which holds a bottom surface of the housing.

5. An removal tool for removing the optical connector according to claim 1 from an optical adapter, comprising:
an operation lever having a front end capable of flexibly moving up and down, wherein under a state in which the operation lever is inserted into the tool insertion hole from the rear side thereof, the front end of the operation lever is positioned above the rear end of the locking lever and a rear end of the operation lever projects rearward from the tool insertion hole.

6. An optical connector-removing structure, comprising:
an optical connector according to claim 1;
an optical adapter to which the optical connector is attached; and
a removal tool for removing the optical connector from the optical adapter, wherein:
the removal tool includes an operation lever having a front end capable of flexibly moving up and down;
a recessed portion is provided in the top surface of the operation lever, and correspondingly a projecting portion is provided in the tool insertion hole of the covering member of the optical connector;
if the recessed portion of the operation lever fits with the projecting portion of the tool insertion hole, a front end of the operation lever inserted into the tool insertion hole is positioned above the rear end of the locking lever; and
if the recessed portion of the operation lever does not fit with the projecting portion of the tool insertion hole, the operation lever inserted into the tool insertion hole is pushed down by the projecting portion of the tool insertion hole, so that the front end of the operation lever cannot be positioned above the rear end of the locking lever.

7. An optical connector-removing structure, comprising:
an optical connector according to claim 1;
an optical adapter to which the optical connector is attached; and
a removal tool for removing the optical connector from the optical adapter, wherein:
the removal tool includes an operation lever having a front end capable of flexibly moving up and down;
a projecting portion is provided in the top surface of the operation lever, and correspondingly a recessed portion is provided in the tool insertion hole of the covering member of the optical connector;
if the projecting portion of the operation lever fits with the recessed portion of the tool insertion hole, a front end of the operation lever inserted into the tool insertion hole is positioned above the rear end of the locking lever; and
if the projecting portion of the operation lever does not fit with the recessed portion of the tool insertion hole, the projecting portion of the operation lever inserted into the tool insertion hole is pushed down by the tool insertion hole, so that the front end of the operation lever cannot be positioned above the rear end of the locking lever.
